(19) United States
(12) Patent Application Publication
(10) Pub. No.: US 2015/0180094 A1
(43) Pub. Date: Jun. 25, 2015

(54) APPARATUS, METHODS OF MANUFACTURE, AND METHODS FOR TESTING AMOUNT OF ENERGY STORED IN ELECTROCHEMICAL CELL

(71) Applicant: CCL LABEL, INC., East Lansing, MI (US)

(72) Inventors: Jamie Rieg, Laurens, SC (US); Anne Shim, Hudson, OH (US); John Walsh, Medina, OH (US); Peikang Liu, Claremont, CA (US); Paul Janousek, Simpsonville, SC (US)

(21) Appl. No.: 14/415,284

(22) PCT Filed: Jul. 18, 2013
(86) PCT No.: PCT/US13/51086

§ 371 Date: Jan. 16, 2015

Related U.S. Application Data
(60) Provisional application No. 61/673,225, filed on Jul. 18, 2012.

(51) Int. Cl. H01M 10/48; H01M 2/02

(52) U.S. Cl. CPC H01M 10/488; H01M 2/0267; H01M 2220/30

(57) ABSTRACT

A battery assembly includes a battery, an outer layer, and a power indicator apparatus. The battery includes a first terminal and a second terminal. The power indicator apparatus comprises an electrical conductor and a mechanical switch. The electrical conductor is configured to be in continuous electrical communication with the first terminal. The mechanical switch is configured to be actuated by an application of pressure at a single location, and upon actuation, to place the electrical conductor in electrical communication with the second terminal such that the power indicator apparatus can facilitate a reading of a potential energy stored in the battery. Methods of assembly and methods of determining a potential energy stored in the battery are also provided herein.

### CROSS-REFERENCE TO RELATED APPLICATION

This application claims the benefit of U.S. Provisional Application No. 61/673,225 filed Jul. 18, 2012 and entitled “Apparatus, Methods of Manufacture, and Method for Testing Amount of Energy Stored in Electrochemical Cell,” which is hereby incorporated in its entirety by reference.

### TECHNICAL FIELD OF THE INVENTION

This disclosure relates generally to apparatuses for determining the amount of energy stored in an electrochemical cell through testing and, more particularly, to determining the amount of electrical power stored in a battery through a user initiated test as well as methods for manufacturing the apparatuses.

### BACKGROUND OF THE INVENTION

Electrochemical cells such as batteries are common sources of electrical power for many consumer, commercial, and industrial applications. Batteries are often purchased and stored for periods of time before being used. During these periods of storage, the energy stored in a battery can partially or fully dissipate. Therefore, a battery can have a finite shelf-life. Apparatus and methods can be utilized to allow for the periodic determination or estimation of the amount or percentage of energy remaining in a battery. Such a determination can assist a user of batteries in selecting a specific battery to use or in deciding when to replace a stored supply of batteries.

### SUMMARY OF THE INVENTION

In accordance with one embodiment, a battery assembly for determining the amount of energy stored in an electromechanical cell is presented. The battery assembly includes a battery having a first and second end cap, and a power indicator apparatus. The power indicator apparatus includes an electrical conductor, coupled to the first end cap, and a mechanical switch. The mechanical switch is configured to place the electrical conductor in electrical communication with the second end cap. The electrical conductor has a tapered thermochromatic conductor to provide a visual indication of the amount of energy stored in the battery when the mechanical switch is closed.

In a further embodiment, the first end cap of the battery has a perimeter wall and groove. The electrical conductor may be connected to the battery by coupling the electrical conductor to the perimeter wall. In a yet further embodiment, the perimeter wall and electrical conductor may be deformed into one another to provide the connection.

In yet another embodiment of the invention, the power indicator discussed in this invention is applied as a label to a battery. As such it has an internal side and an external side. The external side is used as a simple display board that interacts with the internal side and in doing so displays the current energy storage of the battery. The internal side consist of multiple layers including but not limited to a thermal and electric insulating layer that is penetrated in at least one location to enable contact with the battery, a conductive layer that has the ability to connect the two poles without creating a short, an optional printed layer that enables an improved display, a thermally reactive material that changes color when heated up, and the outer film generated from multiple stacks of printed inks and plastic films.

In accordance with another embodiment, a method for determining an amount of energy stored in a battery is presented. The method includes the steps of providing a battery having a power indicator apparatus connected to a first end cap of the battery and a mechanical switch connected to a second end cap of the battery. A visual indication of the amount of energy stored in a battery can be displayed by actuating the mechanical switch to place the electrical conductor in electrical communication with a second end cap of the battery to produce a visual indication on the power indicator apparatus. The method concludes with reading the visual indication to determine the amount of energy stored in the battery.

In accordance with another embodiment, a method for manufacturing a battery assembly for determining the potential energy stored in an electromechanical cell is presented. The method includes a first step of providing a battery having a first and second terminal and then attaching a power indicator apparatus which has an electrical conductor and mechanical switch. Next, the electrical conductor is connected to the first terminal of the battery.

In a still further embodiment, the method for manufacturing a battery assembly for determining the potential energy stored in an electromechanical cell also includes the step of preparing the battery by providing a perimeter groove and perimeter wall in an end cap by stamping, chemical etching, milling, or laser cutting. The method includes the step of connecting the electrical conductor and the perimeter wall. In a yet still further embodiment, the electrical conductor and the perimeter wall are deformed to provide a connection.

In yet another embodiment of the invention, a method of manufacturing the conductive layer of an indicator label is accomplished by printing a conductive material on the internal layer of the indicator label.

In yet another embodiment, a method of manufacturing the conductive layer of an indicator label is accomplished by creating a pattern from a metal foil on the internal layer of the indicator label by an additive technique such as vapor deposition, sputtering, or use of a nucleating agent in a pattern to which metal is subsequently applied.

In yet another embodiment, a method of manufacturing the conductive layer of an indicator label is accomplished by a subtractive process such as, for example, analog die cutting, laser cutting, hot foil stamping, cold foil stamping or etching of a metal foil which can be optionally adhered to a substrate with or without an adhesive material.

### BRIEF DESCRIPTION OF THE DRAWINGS

It is believed that certain examples will be better understood from the following description taken in combination with the accompanying drawings in which:

FIG. 1 is a schematic view depicting a battery assembly in accordance with one embodiment;

FIG. 2 is a schematic view depicting the battery assembly of FIG. 1 having an outer layer partially unassembled from the battery assembly to reveal a battery and a power indicator apparatus;

FIG. 3A is a plan view depicting the power indicator apparatus of FIG. 2;

FIG. 3B is a plan view depicting an electrical conductor of the power indicator apparatus of FIG. 3A;

FIG. 3C is a plan view depicting a mechanical switch of the power indicator apparatus of FIG. 3A and location 32 on FIG. 4;

FIG. 4 is a plan view depicting the battery assembly of FIG. 1 partially unassembled revealing the outer layer and the power indicator apparatus positioned adjacent to the battery;

FIG. 5 is a schematic view depicting the battery of FIG. 2;

FIG. 6 is a schematic view depicting in cross-section the battery of FIG. 2 which illustrates an annular groove and annular wall formed into an end cap;

FIG. 7 is a schematic view depicting the battery, the outer layer, and power indicator apparatus of FIG. 2 prior to assembly into the battery assembly;

FIG. 8 is a schematic view depicting in cross-section the battery, outer layer, and power indicator apparatus of FIG. 2 partially assembled into the battery assembly by shrinking the outer layer onto the battery;

FIG. 8A is a schematic view depicting in cross-section a detailed portion 8A of FIG. 8;

FIG. 9 is a schematic view depicting in cross-section an application of forces to the battery, outer layer, and power indicator apparatus of FIG. 2 during assembly into the battery assembly;

FIG. 10 is a schematic view depicting in cross-section the battery assembly of FIG. 1;

FIG. 10A is a schematic view depicting in cross-section a detailed portion 10A of FIG. 10;

FIG. 11 is a perspective view depicting an operator initiating a reading of an amount of energy stored in the battery assembly of FIG. 1;

FIG. 12 is a plan view depicting the power indicator apparatus positioned on the outer layer of FIG. 2 for the battery assembly of FIG. 1;

FIG. 13 is a plan view depicting a power indicator apparatus positioned on an outer layer for a battery assembly, in accordance with a second embodiment;

FIG. 14 is a plan view depicting a power indicator apparatus positioned on an outer layer for a battery assembly, in accordance with a third embodiment;

FIG. 15 is a plan view depicting a power indicator apparatus positioned on an outer layer for a battery assembly, in accordance with a fourth embodiment; and

FIG. 16 is a plan view depicting a power indicator apparatus positioned on an outer layer for a battery assembly, in accordance with a fifth embodiment.

### DETAILED DESCRIPTION OF THE INVENTION

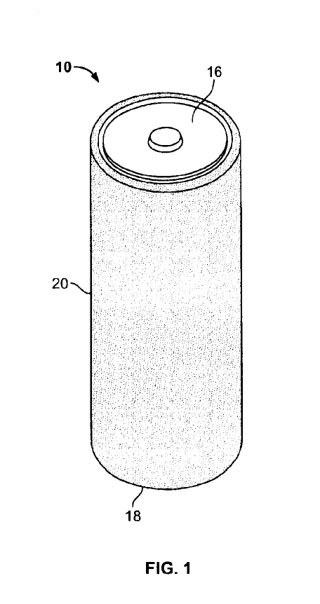

The apparatus and methods disclosed in this document are described in detail by way of examples and with reference to FIGS. 1-16. Unless otherwise specified, like numbers in FIGS. 1-16 indicate references to the same, similar, or corresponding elements throughout FIGS. 1-16. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatus and methods for determining an amount of energy stored in an electrochemical cell are hereinafter disclosed and described in detail with reference made to FIGS. 1-16.

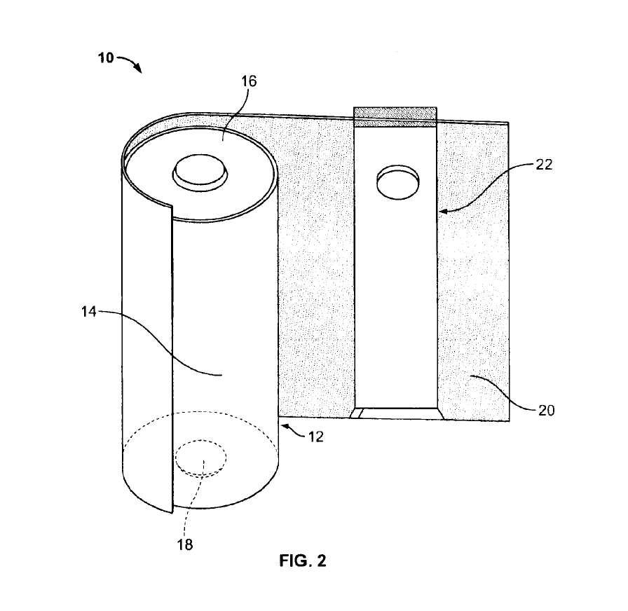

A common source of portable electrical energy that uses one or more electrochemical cells is a dry cell battery. Dry cell batteries can be manufactured and sold in a variety of sizes, configurations, and voltage outputs. For example, common types of consumer batteries are marketed and known as “AA-type,” “AAA-type,” “C-type,” “D-type,” “9-volt-type,” and so on. As illustrated in FIGS. 1 and 2, a battery assembly 10 can comprise a battery 12, an outer layer 20, and a power indictor apparatus 22. The battery 12 can include a cylindrical casing 14, a first end cap 16, and a second end cap 18. The first end cap 16 can at least partially seal a first open end of the casing 14, and the second end cap 18 can at least partially seal a second and opposing open end of the casing 14. Chemicals or other active elements or components used to produce electrical power can be stored within and enclosed by the casing 14, the first end cap 16, and the second end cap 18.

The casing 12, first end cap 14, and second end cap 16 can be joined to form the battery 12. The outer layer 20 can then be wrapped to at least partially cover the battery 12. In one example, the outer layer 20 can be arranged so that it covers the casing 14 and at least a portion of the first end cap 16 and/or a portion of the second end cap 18. The outer layer 20 can include any of a variety of suitable materials or substances. In one example, the outer layer 20 can comprise a relatively thin sheet or film of polyethylene terephthalate (PET). In another example, the outer layer 20 can include a relatively thin sheet or film of a PET copolymer such as PET modified by adding cyclohexane dimethanol to the polymer backbone in place of ethylene glycol to form PETG. As will be further discussed, the outer layer 20 can be a shrink-wrap polymeric film. In such a configuration, heat can be applied to the polymeric film, thereby causing the film to contract or shrink to the outer shape and/or contours of the battery 12. In another embodiment, the outer layer 20 may include PVC (poly vinyl chloride) and a polyolefin comprising a polypropylene and polyethylene blend (PP/PE).

The first end cap 16 and the second end cap 18 can be arranged as polar terminals for the battery 12. The first and second end caps 16 and 18 can further be arranged to be polar opposites. That is, the first end cap 16 can be arranged to be a positive terminal for the battery 12, and the second end cap 18 can be arranged to be a negative terminal for the battery 12. Conversely, the first end cap 16 can be arranged to be the negative terminal, and the second end cap 18 can be arranged to be the positive terminal. It will be understood that any reference to “first end cap” and “second end cap” in this document should not be read to limit such a reference to either a component of a positive terminal or a component of a negative terminal. Furthermore, it will be understood that any reference to “first terminal” and “second terminal” in this document should not be read to limit such a reference to either a positive terminal or a negative terminal.

It will be understood that the casing 14 can also be arranged to form part of a terminal as well. In one example, the first end cap 16 and at least a portion of the casing 14 can comprise the positive terminal and the second end cap 18 can comprise the negative terminal. In such an arrangement, when a conductive material is positioned in contact with the positive terminal (i.e., the first end cap 16 or the casing 14) and in contact with the negative terminal (i.e., the second end cap 18), a circuit can be completed and an electrical current can pass though the conductive material.

The outer layer 20 can be configured to serve a number of functions. In one example, the outer layer 20 can include graphics and/or text to serve as an informational and/or marketing label for the battery assembly 10. For example, the outer layer 20 can include the name and logo of the battery manufacturer and/or the type and voltage of the battery assembly 10. Additionally or alternatively, as further discussed below, the outer layer 20 can facilitate access to an interactive display that selectively indicates the amount of energy remaining in the battery assembly 10. In one example, an adhesive layer can be provided to secure the outer layer 20 to the battery 12.

As previously discussed, the outer layer 20 can comprise a polymeric shrink-wrap film that conforms to the shape and/or contours of the battery 12 upon the application of heat. In such an arrangement, additional layers of material or generally thin apparatus or assemblies can be positioned between the outer layer 20 and the battery 12 prior to the application of heat to the outer layer 20. Upon the application of heat to the outer layer 20, the shrinking and conforming of the outer layer 20 can position and/or secure such additional layers or assemblies relative to the battery 12.

In one example illustrated in FIG. 2, the power indicator apparatus 22 can be positioned between the outer layer 20 and the battery 12. When the outer layer 20 is heated and conforms to the shape of the battery 12, the power indicator apparatus 22 can be positioned and secured so that the power indicator apparatus 22 is arranged to be in electrical communication with at least one of the casing 14, first end cap 16, or second end cap 18. As will be further detailed, the power indicator apparatus 22 can be arranged so that a user of the battery assembly 10 can selectively actuate the power indicator apparatus 22 to determine the amount of energy remaining in the battery assembly 10. In addition, the power indicator apparatus 22 can be arranged so that a user can selectively actuate the power indicator apparatus 22 by applying pressure at a predetermined location along the outer layer 20.

In another example, the power indicator can be applied to the battery as a separate label. In this embodiment, the power indicator has an internal side and an external side. The external side is used as a simple display board that interacts with the internal side and in doing so displays the current energy storage of the battery. The internal side consist of multiple layers including but not limited to a thermal and electric insulating layer that is penetrated in at least one location to enable contact with the battery, a conductive layer that has the ability to connect the two poles without creating a short, an optional printed layer that enables an improved display, a thermally reactive material that changes color when heated up, and the outer film generated from multiple stacks of printed inks and plastic films.

The material set is a critical choice. On one hand, when the two poles of the battery are connected a current must be drawn, hence, the circuit must be made out of a conductive material. On the other hand, the circuit must be enough of a resistor that the battery is not short-circuited and drained within the time it takes to read the display. The resistance of the material is dictated by the desired temperature rise that is required to cause the thermal ink to respond and change color. The typical resistance in a 47 mm path length with a width of 1-5 mm and a height of up to 50 micron (though more desireable up to 20 micron) is 1.3 ohm.

The conductive material can be made of any material that provides satisfactory electrical conductivity and physical/chemical stability. Exemplary conductive materials include carbaneous material such as carbon black, graphite, grapheme, carbon nanotubes or a metal particle (whether spherical or flake like) such as silver, copper, nickel or aluminum. It is also contemplated that combinations of these metals can be used such as in alloys or in layered arrangements such as a core of a less nobel material with a shell made from a more nobel material that protects the less nobel material from undergoing any corrosive reactions that may reduce its conductivity such as a copper core with a silver shell. Another layered arrangement is one in which a layer of copper covers at least a portion of an aluminum layer. When aluminum foils are used, additional processing is preferred to remove a naturally occurring oxide layer on the surface of the foil prior to forming a reliable conductive attachment. This can be performed at the time of attachment or prior to attachment. The freshly exposed aluminum surface with the oxide layer removed is preferably protected by a more stable conductive material as in the case in which the oxide is removed prior to conductive attachment as in solar module manufacturing. One exemplary conductive material is a thin layer of copper, which can be electroplated over the aluminum surface. Although electroplating is noted, it will be appreciated that deposition of the metal such as copper can be performed by other techniques such as sputtering or electroless plating, or printing a conductive material such as silver. The thickness of such copper layer can be in the micron or submicron range. Various methods of treating the aluminum surface have been disclosed in pending U.S. provisional application 61/451,661, which is incorporated herein by reference in its entirety. The treatment on the aluminum surface can be conducted prior to the lamination with the carrier film, or after the lamination. When copper foil is used, it is sometimes protected by a more stable conductive material, such as silver, or organic solderability preservative (OSP). The OSP coating has been demonstrated to provide excellent results for contact points that are usually covered by silver, and has passed the most difficult environmental tests for many thousands of hours. This is a preferred solution for use with copper foil without any silver plating, and hence provides a more economical solution.

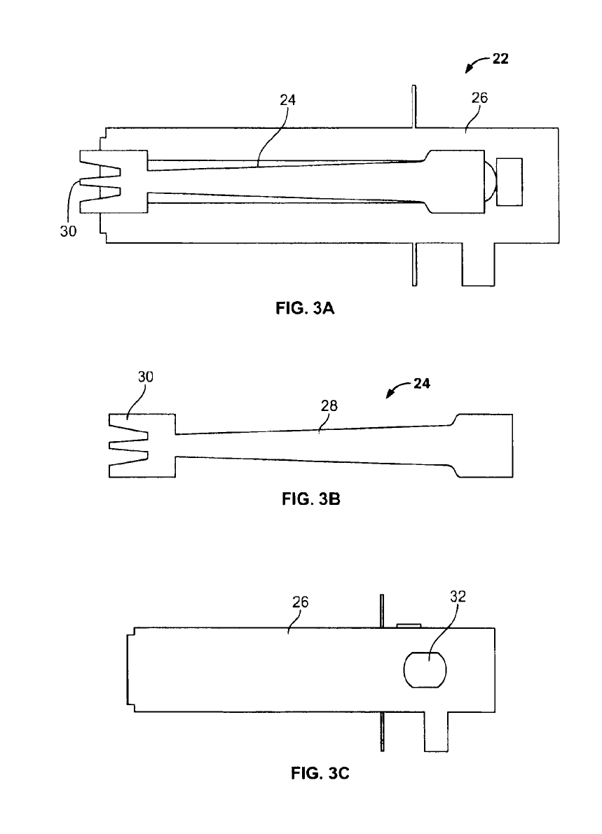

An example of a power indicator apparatus 22 is illustrated in FIG. 3A. The power indicator apparatus 22 can include an electrical conductor 24 and a mechanical switch 26. As shown in FIG. 3B, the electrical conductor 24 can include a tapered body 28 and features 30, such as tabs or posts, extending from one end of the electrical conductor 24. The electrical conductor 24 can be made from any of a variety of suitable electrically conductive materials such as, for example, silver, copper, gold, and the like. The mechanical switch 26 is illustrated in FIG. 3C. The material forming the mechanical switch 26 can have insulative properties so that when the mechanical switch 26 is positioned adjacent to the electrical conductor 24, the mechanical switch 26 can generally insulate all or a portion of the electrical conductor 24 from other components of the battery assembly 10 such as the battery 12.

The mechanical switch 26 can include an aperture 32 through which the electrical conductor 24 can be selectively engaged with proximate or adjacent components. As illustrated in FIG. 3A, a portion of the electrical conductor 24 can be positioned over the aperture 32. Once the battery assembly 10 is assembled, pressure can be applied through the outer layer 20 at or near the aperture 32 to temporarily deform the electrical conductor 24 and/or the mechanical switch 26 and allow electrical communication between the electrical conductor 24 and the battery 12 through the aperture 32. It will be understood that mechanisms such as, for example, leaf springs, cantilevers, detents, resilient materials, cardboard insulators, and the like can be incorporated into the electrical conductor 24 and/or the mechanical switch 26 to facilitate selective electrical communication through the application of pressure on or near the power indicator apparatus 22.

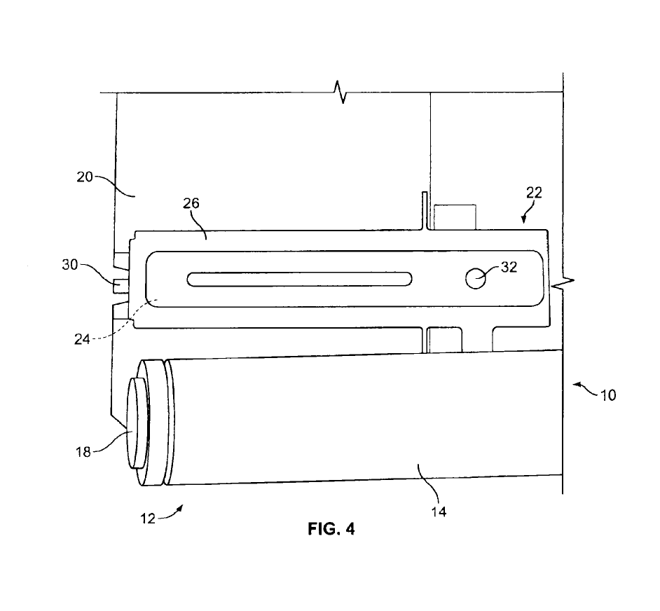

As previously discussed, the power indicator apparatus 22 can be positioned proximate or adjacent to the battery 12. As illustrated in FIG. 4, the power indicator apparatus 22 can be positioned between the outer layer 20 and the battery 12 so that when the outer layer 20 is shrink-wrapped or otherwise secured to the battery 12, the power indicator apparatus 22 can be positioned and secured proximate or adjacent to the battery 12. As illustrated in FIG. 3A, the features 30 of the electrical conductor 24 can extend beyond the mechanical switch 26 such that when the battery assembly 10 is assembled, the features 30 can be generally placed in continuous contact with the second end cap 18, which can be arranged to be the negative terminal of the battery 12.

The mechanical switch 26 can be arranged to selectively insulate the remainder of the electrical conductor 24 from the casing 14 and positive terminal of the battery 12. In such an arrangement, during normal use of the battery assembly 10, no electrical current passes through the electrical conductor 24. However, when a user wants an indication of the energy remaining in the battery 12, the user can manually manipulate the mechanical switch 26 such that a portion of the electrical conductor 24 engages the casing 14 though the aperture 32. The casing 14 forms a portion of the positive terminal of the battery 12. The contact with the positive terminal of the battery 12 completes a circuit through the electrical conductor 24 and causes an electrical current to flow through the electrical conductor 24. The magnitude of the electrical current through the electrical conductor 24 can be dependent upon and, therefore, indicative of, the amount of energy remaining or stored in the battery 12.

Electrical current flowing though the electrical conductor 24 can generate heat in the electrical conductor 24. As illustrated in FIG. 3B, the body 28 of the electrical conductor 24 can be tapered with the width of the electrical conductor 24 varying along its length. Narrow portions of the body 28 can rise to a higher temperature under a given current than broader portions of the body 28. A thermochromatic material can be positioned in contact with or proximate to the electrical conductor 24. The thermochromatic material can be arranged so that heat generated by the electrical conductor 24 can be transferred to the thermochromatic material. The thermochromatic material can respond to the transfer of heat by changing color in proportion to a temperature of the thermochromatic material. It will be understood that the tapered configuration of the electrical conductor 24, the position of the thermochromatic layer relative to the electrical conductor 24, and the configuration of the thermochromatic layer can be arranged to result in a visual indication to a user that corresponds with the amount of energy remaining in the battery assembly 10.

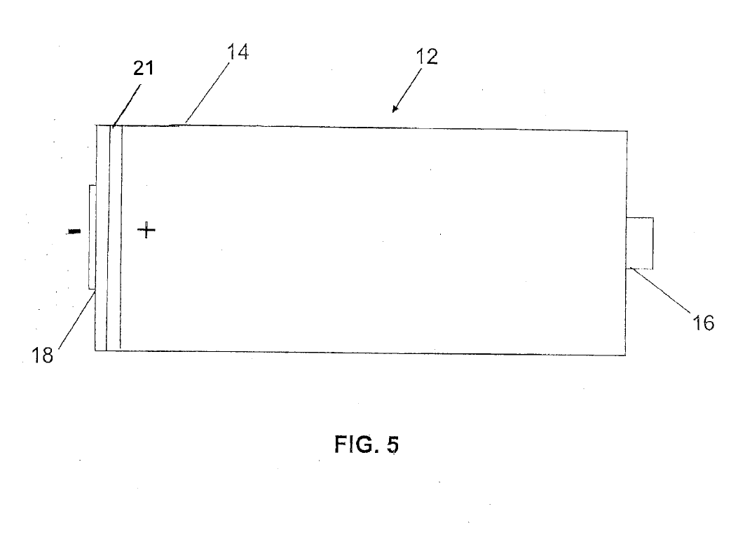

A number of arrangements, apparatus, and/or methods can be employed to encourage a portion of the electrical conductor 24, such as the features 30, to maintain continuous contact with one of the terminals of the battery 12 upon assembly of the battery assembly 10. As illustrated in FIGS. 5-10A, the battery 12 can be modified and assembly methods can be applied that encourage the electrical conductor 24 to maintain continuous contact with a terminal of the battery 12 so as to facilitate electrical communication with that terminal of the battery 12.

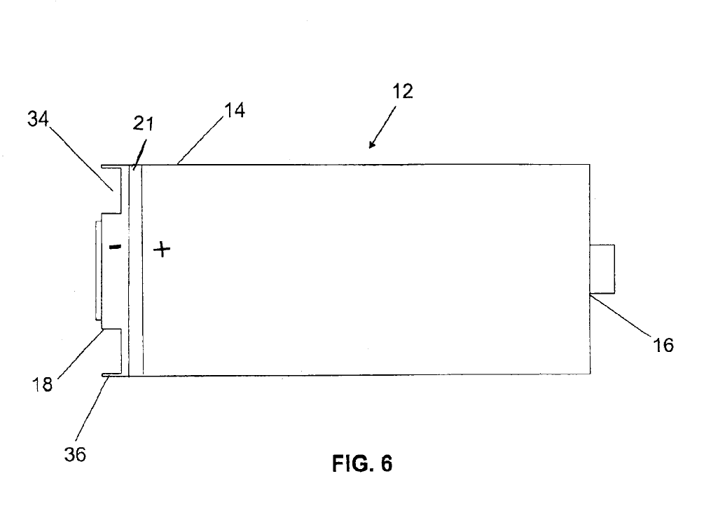

For example, FIG. 5 schematically illustrates a schematic view of the battery 12. As schematically shown in cross-section in FIG. 6, an annular groove 34 can be formed in the second end cap 18 of the battery 12 that results in an annular wall 36 positioned along the perimeter of the second end cap 18. The annular groove 34 can be formed in the second end cap 18 in any of a variety of suitable methods. In one example, the annular groove 34 can be formed by a stamping process during the manufacture of the second end cap 18. In another example, the annular groove 34 can be formed by a laser cutting technique during the manufacture of the second end cap 18 or after the assembly of the battery 12. In another example, the annular groove 34 can be formed by a chemical etching technique during the manufacture of the second end cap 18 or after the assembly of the battery 12. In yet another example, the annular groove 34 can be formed by a milling process during the manufacture of the second end cap 18 or after the assembly of the battery 12. Additional suitable methods of forming the annular groove 34 in the second end cap 18 will be apparent to those of ordinary skill in the art upon reading and understanding the disclosure herein.

The depth of the annular groove 34 can be determined based on the application. In one example, for an AAA-type or AA-type battery assembly, the depth of the annular groove 34 can be approximately 1 millimeter deep. The annular wall 36 can be formed so that the thickness of the annular wall 36 is uniform or generally uniform. This is to say that an inner cylindrical surface of the annular wall 36 is concentric or generally concentric with an outside cylindrical surface of the battery 12 as illustrated in FIG. 6.

It will be understood that the annular groove 34 is described as “annular” because the examples illustrated in the figures are of cylindrical battery assemblies such as AAA-type or AA-type battery assemblies. However, a groove formed in a terminal or an end cap of a battery can be formed in any number of suitable arrangements. For example, a groove can be rectangular in shape to accommodate a 9-volt-type battery. In addition, any wall formed in an end cap can alternatively be arranged such that the wall is not formed along the entire perimeter of an end cap. Material removal or stamping methods can be applied to an end cap to remove or deform material such that one or more isolated tabs, posts, ridges, or the like are formed along or proximate to the perimeter of the end cap. Furthermore, methods can be employed to weld, bond, adhere, or otherwise secure isolated posts, tabs, ridges, and the like so as to be located at, or proximate to, the perimeter of an end cap and to extend above a surface of the end cap.

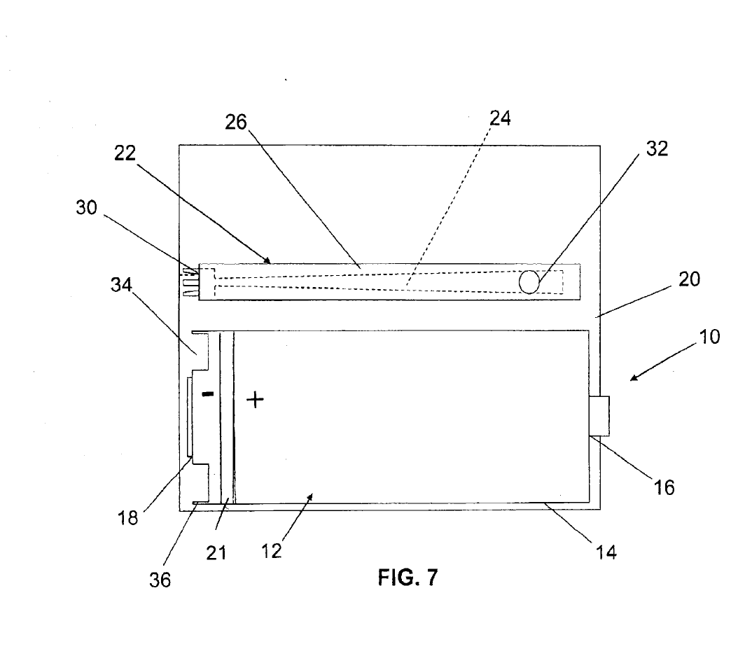

Once the battery 12 is modified to include the annular groove 34 as shown in FIG. 6, the battery 12, outer layer 20, and power indicator apparatus 22 can be arranged to facilitate assembly of the components into the battery assembly 10. A washer 21 may be utilized in the battery assembly 10 to distinguish between the positive and negative areas of the battery 12 as illustrated in FIG. 5-10A. As schematically illustrated in FIG. 7, the power indicator apparatus 22 can be positioned on the outer layer 20 so that upon assembly of the components into the battery assembly 10, the features 30 of the electrical conductor 24 can maintain continuous contact with the second end cap 18. Specifically, the features 30 can maintain continuous contact with the annular wall 36 of the second end cap 18 upon assembly. In an arrangement where the second end cap 18 is the negative terminal and the casing 14 and the first end cap are the positive terminal, the power indicator apparatus 22 can be arranged such that the electrical conductor 24 can be selectively engaged with the casing 14 through the aperture 32. Such an arrangement allows for the periodic testing of the amount of energy remaining in the battery 12. It will be understood that in examples where isolated posts, tabs, ridges, or the like are formed in the second end cap 18, the features 30 of the electrical conductor 24 can be positioned so that the features 30 align with and contact such posts, tabs, ridges, or the like upon assembly of the battery assembly 10.

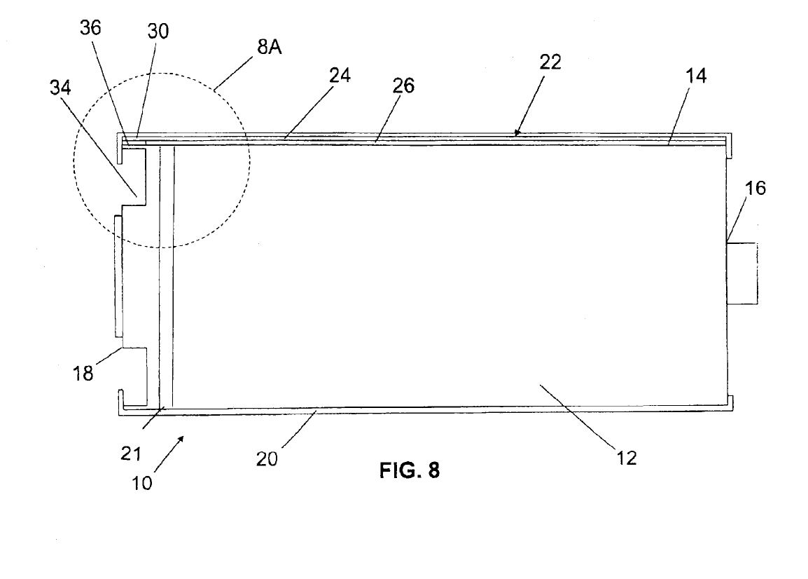

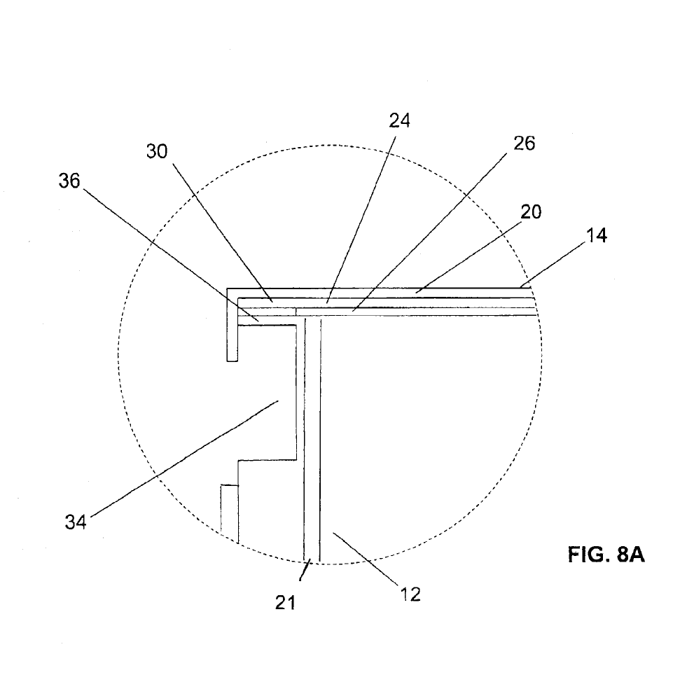

A partially assembled battery assembly 10 is schematically illustrated in cross-section in FIGS. 8 and 8A. The outer layer 20 has been positioned around the battery 12 so that the features 30 of the electrical conductor 24 are placed proximate to the annular wall 36 of the second end cap 18. The mechanical switch 26 can be positioned between the electrical conductor 24 and the battery 12 so as to insulate the electrical conductor 24 from the casing 14 of the battery 12 but allow for contact between the features 30 and the annular wall 36.

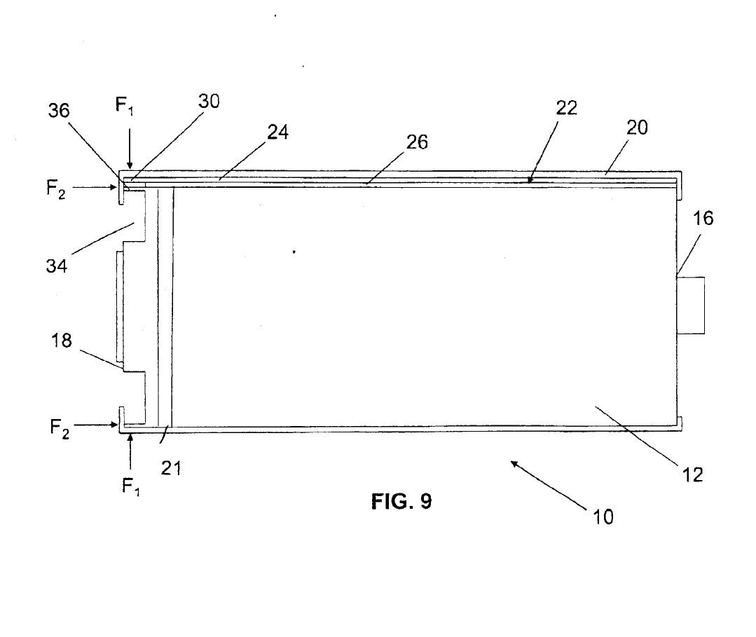

Additional manufacturing steps can be employed to encourage the features 30 to continuously contact the negative terminal through the annular wall 36 upon final assembly of the battery assembly 10. One example of such a manufacturing step is schematically illustrated in cross-section in FIG. 9. Forces F₁, F₂ can be applied to the features 30 and annular wall 36 during the assembly of the battery assembly 10 to crimp the features 30 and annular wall 36 into contact with one another. This is to say that the forces F₁, F₂ are applied so that the features 30 and annular wall 36 are deformed in a generally similar direction and generally similar manner and that the features 30 and annular wall 36 are brought in contact with one another and remain in contact with one another after completion of the assembly process.

In one example, the forces F₁, F₂ can be applied by the outer layer 20 as the outer layer 20 is shrink-wrapped and conforms to the contours of the battery 12. In another example, the forces F₁, F₂ can be applied mechanically by a punch, die, press or other such tool or arrangement configured to directly or indirectly engage and deform the features 30 and/or annular wall 36. Additionally, the forces F₁, F₂ can be applied by a combination of shrink-wrapping of the outer layer 20 and application of mechanical force by a tool. Although two discrete forces F₁, F₂ applied radially and tangentially are illustrated in FIG. 9, it will be understood that any number of suitable forces can be applied at any number of suitable angles or directions to crimp the features 30 and annular wall 36 into contact with one another.

To facilitate assembly methods as described herein, the features 30 and annular wall 36 can be arranged such that they deform in predictable ways under the forces applied during assembly. For instance, the thickness of the features 30 and annular wall 36 can determine the degree of deformation experienced upon the application of a specific set of forces. Therefore, the features 30, annular wall, and forces applied can be designed to achieve repeatable and predictable results so that the features 30 maintain continuous contact with the negative terminal though the annular wall 36 upon final assembly of the battery assembly 10.

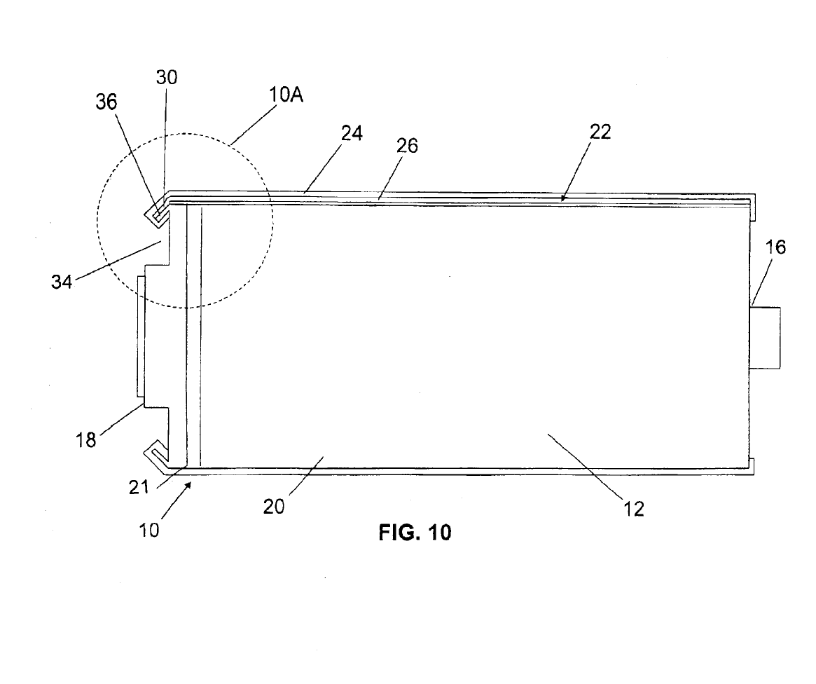

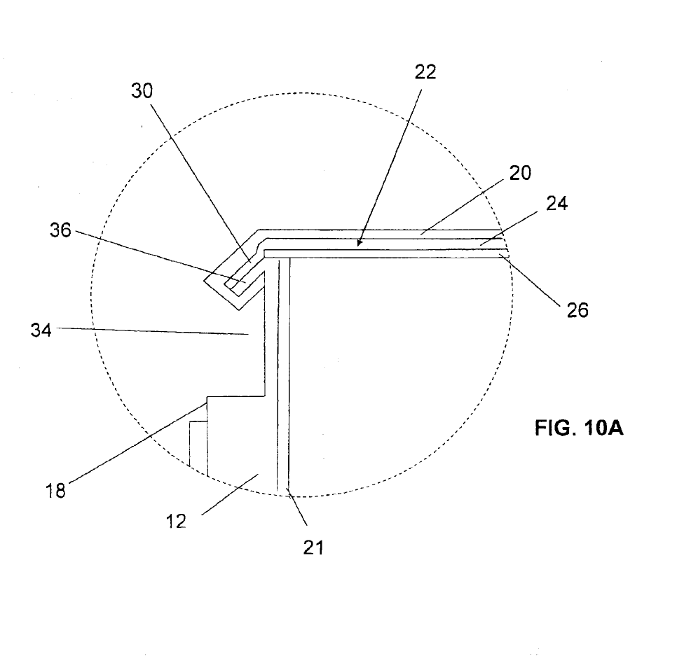

FIGS. 10 and 10A schematically illustrate in cross-section one example of a fully assembled battery assembly 10. As shown, shrink-wrapping of the outer layer 20 and/or crimping of the features 30 and annular wall 36 can result in the features 30 of the electrical conductor 24 and the annular wall 36 of the second end cap 18 maintaining continuous contact with one another. As will be further discussed, such continuous contact facilitates the use of the power indicator apparatus 22 to approximate the amount of energy remaining in the battery assembly 10. As shown in FIGS. 10 and 10A, the outer layer 20 can be arranged so that upon shrink-wrapping, the outer layer 20 fully encloses the features 30 and annular wall 36. In one example, the outer layer 20 can be arranged so that there is a one millimeter overhang past the features 30 prior to shrink-wrapping of the outer layer 20. Such an arrangement can result in the outer layer 20 enclosing of the features 30 and annular wall 36. It will be understood that the outer layer 20 can be arranged to cover more of less of the second end cap 18 upon shrink-wrapping depending on the intended use and application of the battery assembly 10. The outer layer 20 can be further arranged so that after shrink-wrapping, the outer layer 20 maintains a force on the features 30 to continue to encourage contact between the features 30 and the annular wall 36.

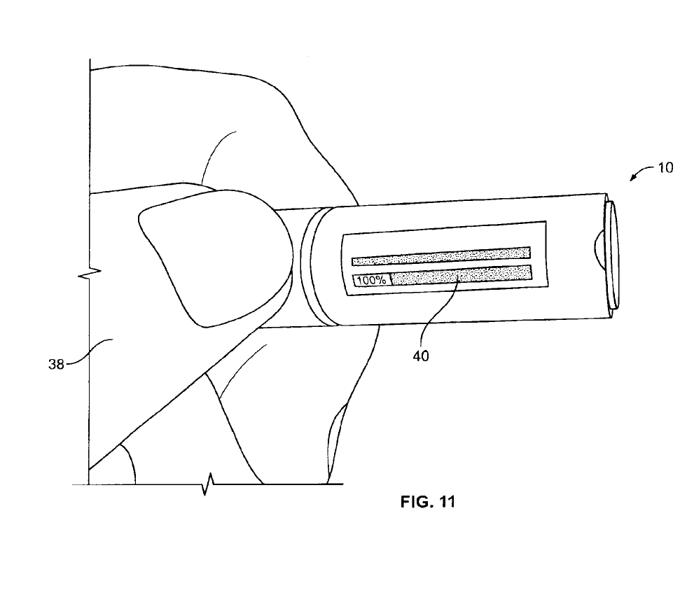

FIG. 11 illustrates a user initiating a reading of the amount of energy remaining in the battery assembly 10. The user initiates the reading by placing pressure on or near a predetermined location of the outer layer 20. The user can apply pressure using a single digit, in this case the user's thumb 38. Pressure is applied at a location on the outer layer 20 that generally corresponds with the location of the aperture 32 of the mechanical switch 26 that is positioned under the outer layer 20 and proximate to the casing 14. The location along the outer layer 20 that initiates a reading can be marked for the user by a graphic on the outer layer 20. The power indicator apparatus 22 can be arranged so that when pressure is placed adjacent to the aperture 32 of the mechanical switch 26, the electrical conductor 24 and/or the mechanical switch 26 deflects and the electrical conductor 24 physically engages the casing 14 through the aperture 32. Thus, a circuit is completed through the electrical conductor 24. Such an arrangement allows for the user to selectively actuate the power indicator apparatus 22 to initiate a reading. As illustrated in FIG. 11, a dynamic graphic 40 on the outer layer 20 can display a reading that estimates the amount of energy stored in the battery assembly 10.

Although the electrical conductor 24 is described as generally remaining in contact with the negative terminal of the battery 12 and selectively engaging with the positive terminal of the battery 12, it will be understood that the electrical conductor 24 can alternatively be arranged so that the electrical conductor 24 generally remains in contact with the positive terminal and is selectively engaged with the negative terminal.

The power indicator apparatus 22 can be attached to the outer layer 20, and the outer layer 20 can be attached to the battery 12. As previously discussed, the position of the power indicator apparatus 22 relative to the battery 12 can therefore be determined by the manner in which the outer layer 20 is shrink-wrapped or otherwise secured to the battery 12. When the outer layer 20 is a polymeric shrink wrap film that shrinks to fit around the battery 12 upon heating, the position of the power indicator apparatus 22 to the pre-shrunk outer layer 20 can determine the position of the power indicator apparatus 22 relative to the battery 12 after the outer layer 20 is shrunk. In particular, the position of the power indicator apparatus 22 can determine if a portion of the electrical conductor 24 will generally remain in continuous contact with the negative terminal of the battery 12 upon shrinking of the outer layer 20. As seen in FIG. 7, prior to the shrinking of the outer layer 20, a portion of the outer layer 20 can extend beyond the second end cap 18. As the outer layer 20 shrinks, the portion of the outer layer 20 extending beyond the second end cap 18 of the battery 12 can wrap around to cover a portion of the second end cap 18 and annular wall 36 (as shown in FIGS. 8-10A). By careful positioning of the electrical conductor 24 relative to the outer layer 20, the position of the electrical conductor 24 relative to the second end cap 18 upon shrink-wrapping of the outer layer 20 can be controlled.

A number of variables can be arranged to control the final positioning of the power indicator apparatus 22 relative to the battery 12. For example, a portion of the electrical conductor 24 (i.e., the features 30) can generally extend beyond the mechanical switch 26 as illustrated in FIG. 3A, for example. The arrangement of the extension of the electrical conductor 24 beyond the mechanical switch 26 can determine how large a portion of the electrical conductor 24 is in contact with the second end cap 18 upon shrink-wrapping of the outer layer 20. In another example, the portion or features 30 of the electrical conductor 24 that do extend beyond the mechanical switch 26 can be arranged in various geometries.

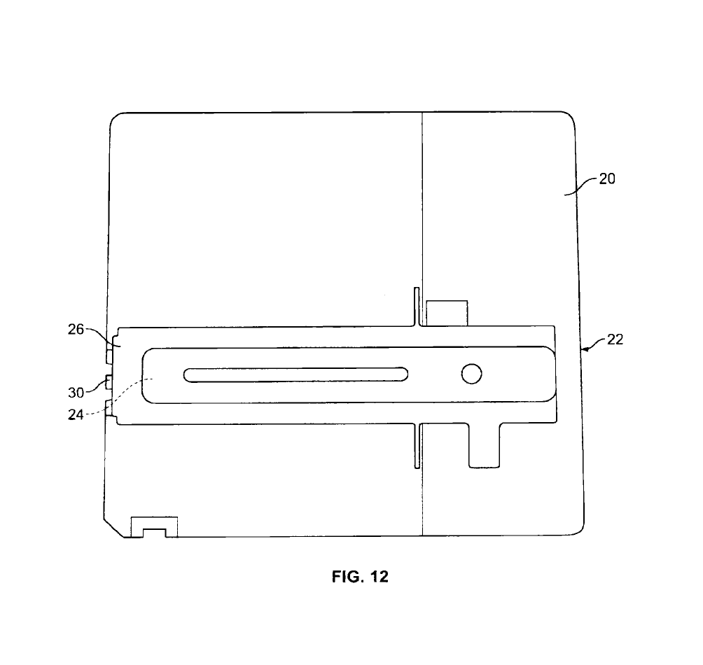

An example of the power indicator apparatus 22 positioned on the outer layer 20 prior to shrink-wrapping on the battery is illustrated in FIG. 12. The end of the electrical conductor 24 is positioned to align with the edge of the outer layer 20. The electrical conductor 24 includes three features 30 or tabs that extend beyond the mechanical switch 26. As the outer layer 20 shrinks, a portion of the outer layer 20 wraps around the second end cap 18 and the annular wall 36 and conforms to the shape of the second end cap 18.

The features 30 can be wrapped around the second end cap 18 and the annular wall 36 through a number of methods. For example, the features 30 can be wrapped around the second end cap 18 and annular wall 36 by the mechanical forces F₁ and F₂ illustrated in FIG. 9 and described above. In one example, a portion of the mechanical switch 26 can also wrap around a portion of the second end cap 18 and the annular wall 36 to cover at least a portion of the second end cap 18. Such an arrangement can provide an insulating layer to guard against a portion of the electrical conductor 24 coming into contact with the casing 14, which can be arranged to be part of the positive terminal. In addition, the outer layer 20 and mechanical switch 26 can be arranged to wrap around a portion of the first end cap 16 upon shrink-wrapping to guard against the electrical conductor 24 coming into contact with the first end cap 16, which can be arranged to be part of the positive terminal.

Features 30 of the electrical conductor 24 can be configured in a variety of suitable arrangements to facilitate electrical communication for a variety of different batteries. Batteries can have different geometries, different positive and/or negative terminals, and different material compositions. The electrical conductor 24, the features 30 of the electrical conductor 24, the mechanical switch 26, and the outer layer 20 can be arranged so as to form a generally continuous electrical contact with the positive or negative terminal of the battery 12 upon the shrink-wrapping of the outer layer 20 to the battery 12.

In an example, prior to the shrink-wrapping of the outer layer 20 to the battery 12, a conductive adhesive can be applied to the exposed portion of the electrical conductor 24 or to the second end cap 18. Upon the shrink-wrapping of the outer layer 20, the conductive adhesive can bond the electrical conductor 24 to the second end cap 18. Such bonding can further maintain continuous contact between the second end cap 18, which can be configured to be one of the terminals of the battery 12, and the electrical conductor 24.

In yet another embodiment, the power indicator can be applied as a label to the battery using an adhesive or other conventional securing means.

The methods which can be utilized for manufacture of the power indicator as a label which is applied to a battery is partially dictated by the cost restriction and partially by the material itself. In general, the processing method must create a pattern out of the desired conductive material on a scale that is comparable to that of the final device.

One option that fulfills the above design criteria is to utilize a printable conductive material. The printing methods can be screen, gravure, silk, flexo or inkjet printing. The materials used with these options are those which were described hereinbefore such as inks with the conductive component being a carbaneous material such as carbon black, graphite, grapheme, carbon nanotubes or a metal particle (whether spherical or flake like) such as silver, copper, nickel or aluminum as well as an alloy or an engineered particle with multiple layers as described previously. The use of printed sintered nanocopper or nanosilver can also be used to form the conductive layer.

Another option that meets the requirements is to create a pattern out of a metal foil. Such pattern may be created using either additive or substractive techniques. The most commonly used additive technique is to use patterned vapor deposition where the conductive material is patterned in the deposition process by using a sacrificial oil. Another additive technique is to pre-print a substrate with a nucleating agent and subsequently depositing the desired conductive material in the desired pattern. Subtractive processes are more commonly used and include diecutting, whether using analog technology such as dies, or digital technologies such as laser cutting, stamping either using hot foil or cold foil stamping techniques, or etching of a metal foil. Diecutting technologies which are useful in connection with the manufacture of the conductive power indicator label of the present invention are more fully described in US Published Application No. 2012/0064307 (application Ser. No. 13/160,289), which is incorporated herein by reference. The conductive materials used for these applications are typically metal foils such as, for example, silver, copper or aluminum foils. These foils may be alloys of copper and manganese to better control the conductivity or they may be clad foils to protect against the environment such as silver clad copper or nickel clad copper. The foil may optionally use an adhesive to adhere the metal to an optional support substrate. The support substrate can be a paper or a plastic which can be either thermally stable or heat shrinkable.

The power indicator apparatus 22 has heretofore been described and illustrated to include multiple separate components. It will be understood that two or more of the components of the power indicator apparatus 22 can be manufactured together, or that any component can be an assembly of multiple subcomponents. In one example, all the components of the power indicator apparatus 22 can be printed onto a substrate. In another example, the electrical conductor 24 can be printed onto the mechanical switch 26 or printed onto another insulating component. In addition, adhesives can be used to secure the power indicator apparatus 22 or individual components thereof to the battery 12.

In another embodiment, the power indicator apparatus 22 as disclosed herein can be used to temporarily power an electrical device (not shown) upon the actuation of the mechanical switch 26. A second switch may be provided in connection with certain configurations. When the mechanical switch 26 is actuated to close the circuit and cause electrical current to flow through the electrical conductor 24, the current can be directed to the electrical device. For example, packaging for a consumer item can be arranged so that a consumer can apply pressure to a specified location on the packaging to actuate the mechanical switch 26 or switches if necessary. Instead of generating only heat with the resulting current, the current can be directed to a lighting source that illuminates a portion of the packaging that identifies the company selling the product, an important fact or product advantage, a price of the product, and the like.

Although this disclosure generally describes the mechanical switch 26 as having insulative properties so as to function as an insulator for the electrical conductor 24, it will be understood that a separate insulating material can also be provided to insulate the electrical conductor 24 from undesired contact with the positive and/or negative terminals or other components of the battery 12. The separate insulating material may be constructed out of a standoff material 131 such as cardboard, paper, or the like. The additional standoff provides increased insulating properties. Alternatively, or in addition to a standoff 131, the electrical conductor may be insulated by an air gap 132. Air provides a superior heat transfer compared to cardboard or paper. The air gap 132 may be a die cut, punched slot, or the like.

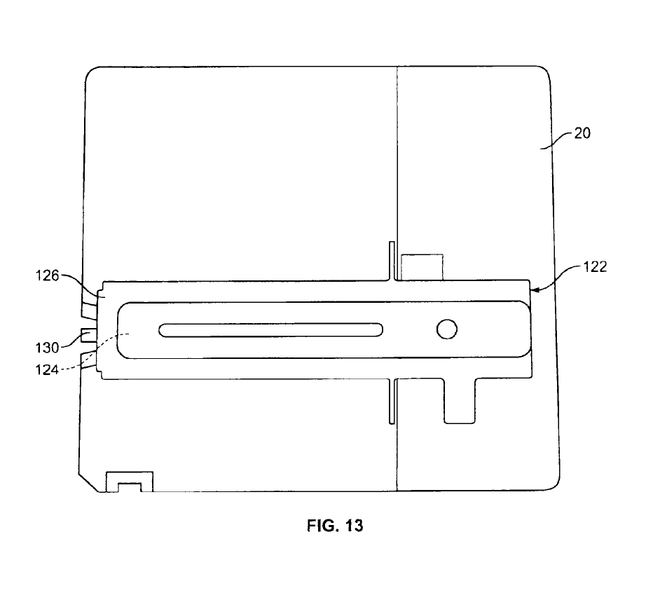

Another embodiment of a power indicator apparatus 122 is illustrated in FIG. 13. The power indicator apparatus 122 can be positioned on the outer layer 20 prior to shrink-wrapping of the outer layer 20 to the battery 12. The arrangement illustrated in FIG. 13 is similar to the arrangement illustrated in FIG. 12 in that an end of an electrical conductor 124 of the power indicator apparatus 122 is positioned to align with an edge of the outer layer 20, and the end of the electrical conductor 124 includes three features 130 or tabs. However, a mechanical switch 126 of the power indicator apparatus 122 is arranged so that a larger portion of the electrical conductor 122 is exposed beyond the mechanical switch 126. Such an arrangement can provide for a larger contact area between the electrical conductor 124 and a second end cap of a battery (such as the second end cap 18 of battery 12) and/or can account for greater variations in the shrinkage of the outer layer 20.

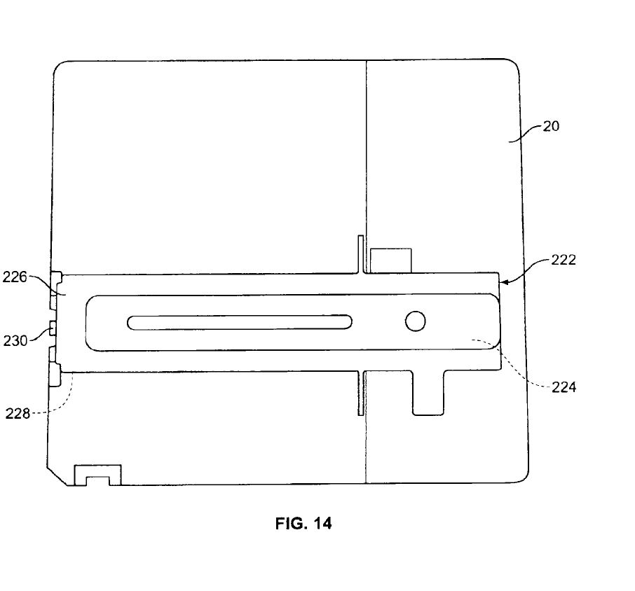

Yet another embodiment of a power indicator apparatus 222 is illustrated in FIG. 14. The power indicator apparatus 222 can be positioned on the outer layer 20 prior to shrink-wrapping of the outer layer 20 to the battery 12. An end of an electrical conductor 224 of the power indicator apparatus 222 is shown to be positioned to align with an edge of the outer layer 20. The end of the electrical conductor 224 is shown to include a feature 230 or T-shaped post. The feature 230 is shown to be generally wider than a body 228 of the electrical conductor 224. A mechanical switch 226 of the power indicator apparatus 222 can provide for a portion of the feature 230 to be exposed beyond the mechanical switch 226. The T-shape of the feature 230 can provide for a substantial surface area by which to achieve effective electrical communication of the electrical conductor 224 with a second end cap of a battery (such as the second end cap 18 of battery 12) upon the shrink-wrapping of the outer layer 20 to the battery 12.

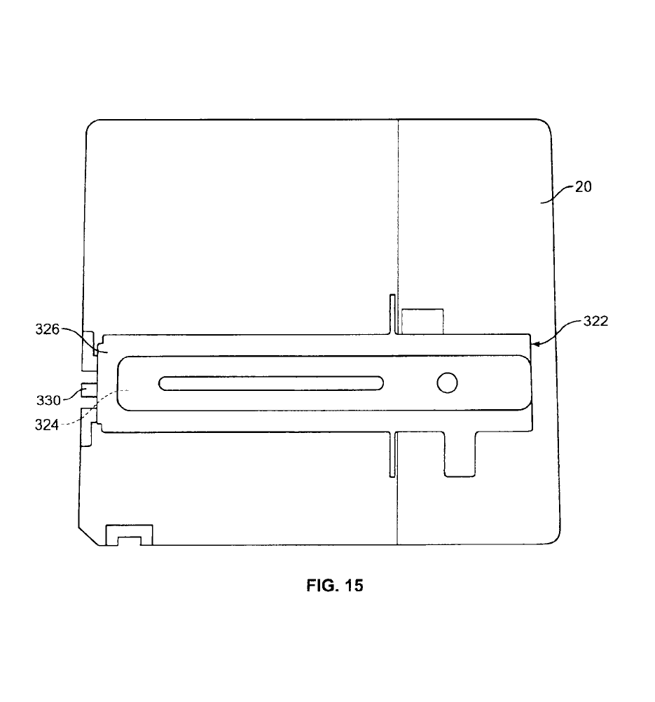

Yet another embodiment of a power indicator apparatus 322 is illustrated in FIG. 15. The power indicator 322 is shown to be positioned on the outer layer 20 prior to shrink-wrapping of the outer layer 20 to the battery 12. The arrangement illustrated in FIG. 15 is similar to the arrangement illustrated in FIG. 14 in that an end of an electrical conductor 324 of the power indicator apparatus 322 is positioned to align with an edge of the outer layer 20, and the end of the electrical conductor 324 includes a T-shaped feature 330. However, a mechanical switch 326 of the power indicator apparatus 322 provides for a larger portion of the feature 330 and a portion of the electrical conductor 324 to be exposed beyond the mechanical switch 326. Such an arrangement can provide for a larger contact area between the electrical conductor 324 and a second end cap of a battery (such as the second end cap 18 of battery 12) and/or can account for greater variations in the shrinkage of the outer layer 20.

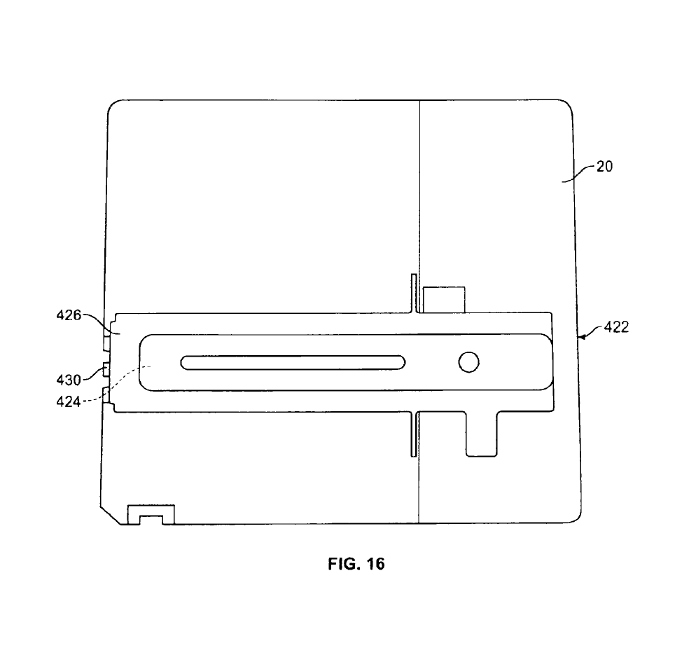

Yet another embodiment of a power indicator apparatus 422 is illustrated in FIG. 16. The power indicator apparatus 422 is shown to be positioned on the outer layer 20 prior to shrink-wrapping of the outer layer 20 to the battery 12. An end of the electrical conductor 424 of the power indicator apparatus 422 is shown to be positioned to align with an edge of the outer layer 20, and to include an extended feature 430. A mechanical switch 426 of the power indicator apparatus 422 can provide for a portion of the electrical conductor 424 to be exposed beyond the mechanical switch 426. As shown in FIG. 16, the extended feature 430 extends a relatively short distance beyond the mechanical switch 426. However, it will be understood that the extended feature 430 can be arranged in any of a variety of suitable lengths to vary the amount it extends past the mechanical switch 426 to provide for effective electrical communication of the electrical conductor 424 with a second end cap of a battery (such as the second end cap 18 of battery 12).

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

1. A battery assembly for determining the amount of energy stored in an electromechanical cell, the battery assembly comprising:
a battery having, a first end cap with a first perimeter, and a second end cap with a second perimeter;
a power indicator apparatus in the form of a label having at least a conductive material layer; and
wherein the power indicator is applied to the battery as a label.

2. A method of making a power indicator for a battery comprising forming a conductive layer on an inner layer of a multilayer construction wherein the conductive layer can be formed by printing, additive patterning or subtractive patterning of the conductive material.

3. The method of claim 2 wherein the printing can be screen, gravure, silk, fleco or inkjet printing.

4. The method of claim 2 wherein the additive patterning can be vapor deposition, sputtering, or by preprinting with a nucleating agent and depositing conductive material thereon to form a desired pattern of conductive material.

5. The method of claim 2 wherein the subtractive patterning can be diecutting, stamping or etching.

6. The method of claim 5 wherein the diecutting can be analog dies or laser diecutting.

7. The method of claim 5 wherein the stamping can be cold or hot stamping.

8. The method of claim 5 wherein the etching can be mechanical or chemical.

9. The method of claim 2 wherein the conductive material can further be attached to a substrate.

10. The method of claim 9 wherein the attachment to the substrate can be an adhesive attachment.

11. The method of claim 9 wherein the substrate can be paper or plastic.

12. The method of claim 11 wherein the plastic can be thermally stable or heat shrinkable.

13. The method of claim 2, wherein the conductive layer by printed sintered nanocopper, nanosilver, or a combination thereof.

14. A product produced in accordance with the method of claim 2.
